(19) United States
(12) Patent Application Publication
(10) Pub. No.: US 2017/0286818 A1
(43) Pub. Date: Oct. 5, 2017

(54) INTERACTIVE ITEM DISPLAY SYSTEM

(71) Applicant: DAVID CENSI, Muttontown, NY (US)

(72) Inventor: DAVID CENSI, Muttontown, NY (US)

(21) Appl. No.: 14/943,021

(22) Filed: Nov. 16, 2015

(51) Int. Cl. G06K 19/07; G06K 7/10

(52) U.S. Cl. CPC G06K 19/0723; G06K 7/10425

(57) ABSTRACT

An interactive item display system, having a display structure adapted to removably support at least one item, said item having at least one radio frequency identification (RFID) tag affixed thereto, an RFID reader, said RFID tag in a first identifying signal state detected by said RFID reader when the item is in a first configuration in removable support by said display structure, said RFID tag in a second identifying signal state detected by said RFID reader when the item is in a second configuration unsupported by said display structure, and an I/O device adapted to transmit information about said item upon detection of said second identifying signal state.

### CROSS-REFERENCE TO RELATED APPLICATIONS

This application claims the benefit of U.S. Provisional Application No. 62/080,379 and U.S. Provisional Application No. 62/134,678, the disclosures of which are incorporated by reference herein in their entirety.

### BACKGROUND OF THE DISCLOSURE

### Field of the disclosure

This disclosure relates to a system of displaying and making available for handling items to interested persons, such as customers, in a way that informs such persons about the items. The items may be for sale, for display in an educational environment, or and any other environment where knowledge of the items displayed is to be imparted.

### Description of the related art

Radio frequency identification (RFID) technology utilizing active or passive tags that are read by an RFID reader are known in the art. It is known to put samples on display for manipulation by customers and to put products for sale on display on shelves, racks, and other means.

### BRIEF SUMMARY OF THE DISCLOSURE

An interactive item display system, having a display structure adapted to removably support at least one item, said item having at least one radio frequency identification (RFID) tag affixed thereto, an RFID reader, said RFID tag in a first identifying signal state detected by said RFID reader when the item is in a first configuration in removable support by said display structure, said RFID tag in a second identifying signal state detected by said RFID reader when the item is in a second configuration unsupported by said display structure, and an I/O device adapted to transmit information about said item upon detection of said second identifying signal state.

### BRIEF DESCRIPTION OF THE DRAWINGS

FIG. 1 shows components of an embodiment of the disclosure.

FIG. 2 shows an embodiment of a process of the disclosure.

FIG. 3 shows a flowchart of another embodiment of a process of the disclosure.

FIG. 4 is a block diagram of an embodiment of the disclosure.

### DETAILED DESCRIPTION OF THE DISCLOSURE

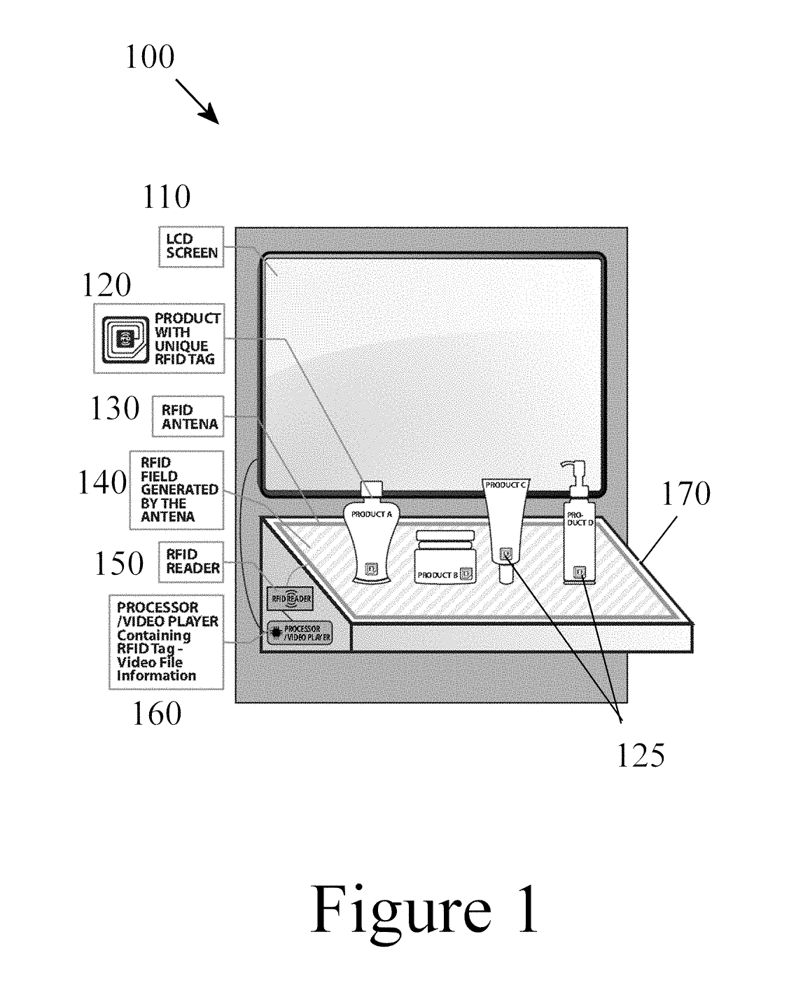

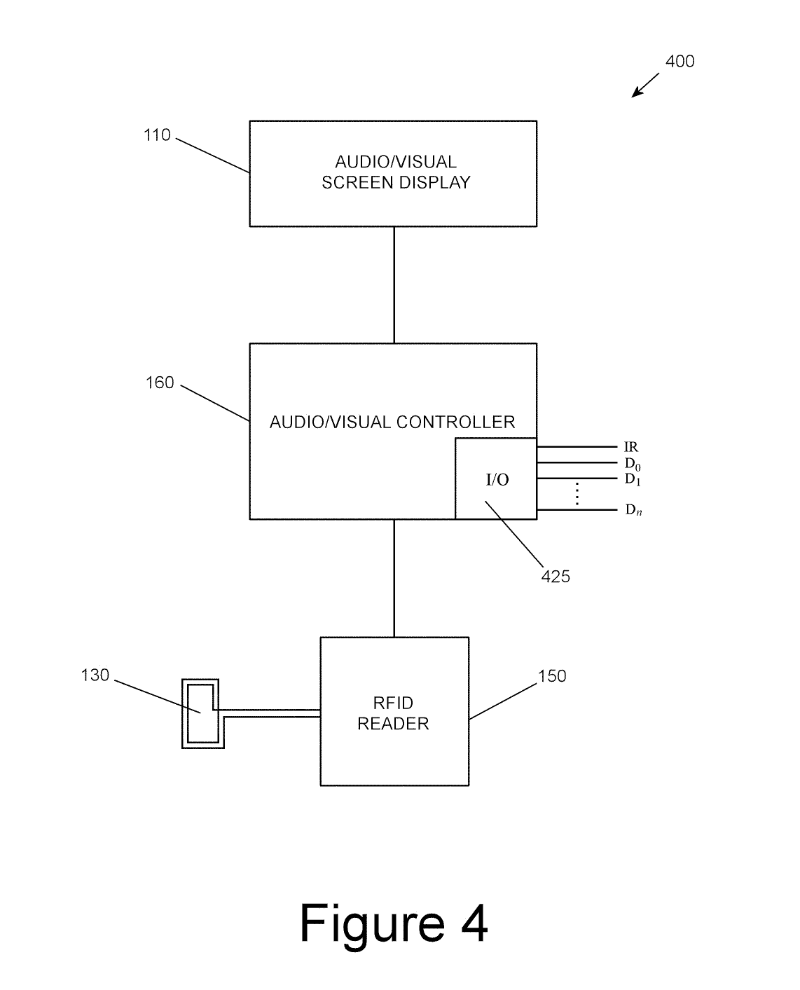

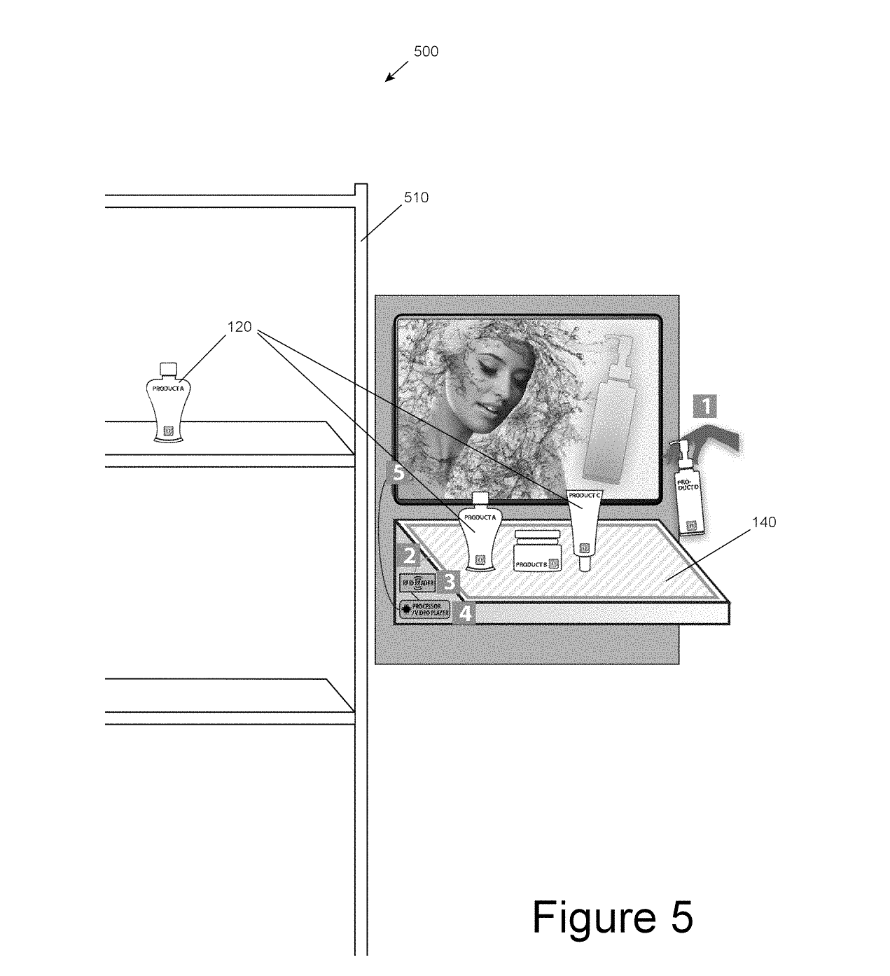

Referring to FIGS. 1 and 4, an interactive item display system 100 of the disclosure is shown having at least one display structure 170 configured to removably support one or more items 120 on display. In a market context, the “items” will usually be products and/or product samples. In this case, the display structure shown is a horizontal shelf or table surface. Other display structures could easily include vertical racks of hooks or shelves, and so forth. The underlying principle is that the user, who may be a shopper, a student, or a museum visitor has access to the items 120 and may pick them up or otherwise remove them from the display structure 170 at her leisure. For the purposes of this disclosure, we will hereinafter refer to such interested persons as “customers” for the sake of simplicity, whether their interest is a market one or not. Further, we will hereinafter refer to the

Each item 120 has at least one RFID tag 125, which may be passive or active. An RFID reader 150 is provided with the general area of the display structure 170. The reader will generally have its own internal reader antenna array 130 or, as shown here, a remote reader antenna array 130 that is incorporated into some other component of the interactive display system 100, such as the display structure 170 as shown. The antenna is placed to offer substantially complete coverage by an RF field 140 across the display structure so as to activate all the RFID tags on all the items 120.

The reader antenna array 130 of the RFID reader 170 will comprise one or more antenna for sending and receiving signals and be positioned such that the display structure is interposed between the reader antenna array 130 and the items, or generally co-located with the reader antenna array 130. The positioning may generally be such as to generate a field that is roughly homogenous over the 3-D space occupied by the items 120 when we are utilizing passive RFID tags 125, such that when an item 120 is removed from the display structure 170 to a distance from the display structure 170 far enough away that the RFID tag 125 is no longer able to return a signal that the RFID reader 150 can see, that this distance, the distance when the “signal event” (i.e., a change in signal—here a loss of signal) occurs is reasonably the same for all the items 120 supported on the display structure 170.

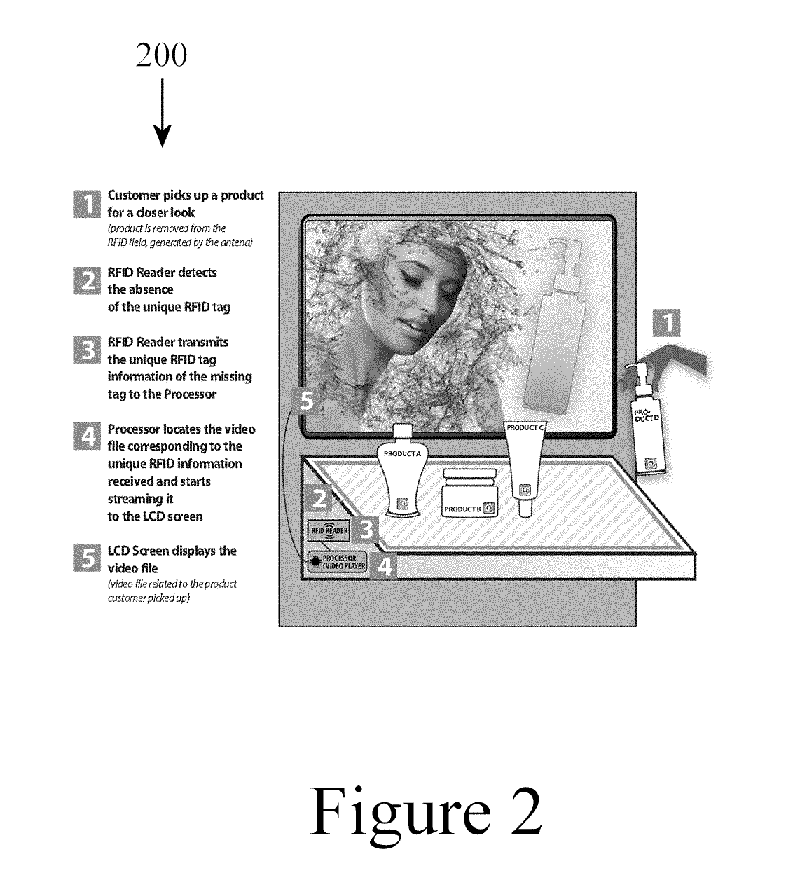

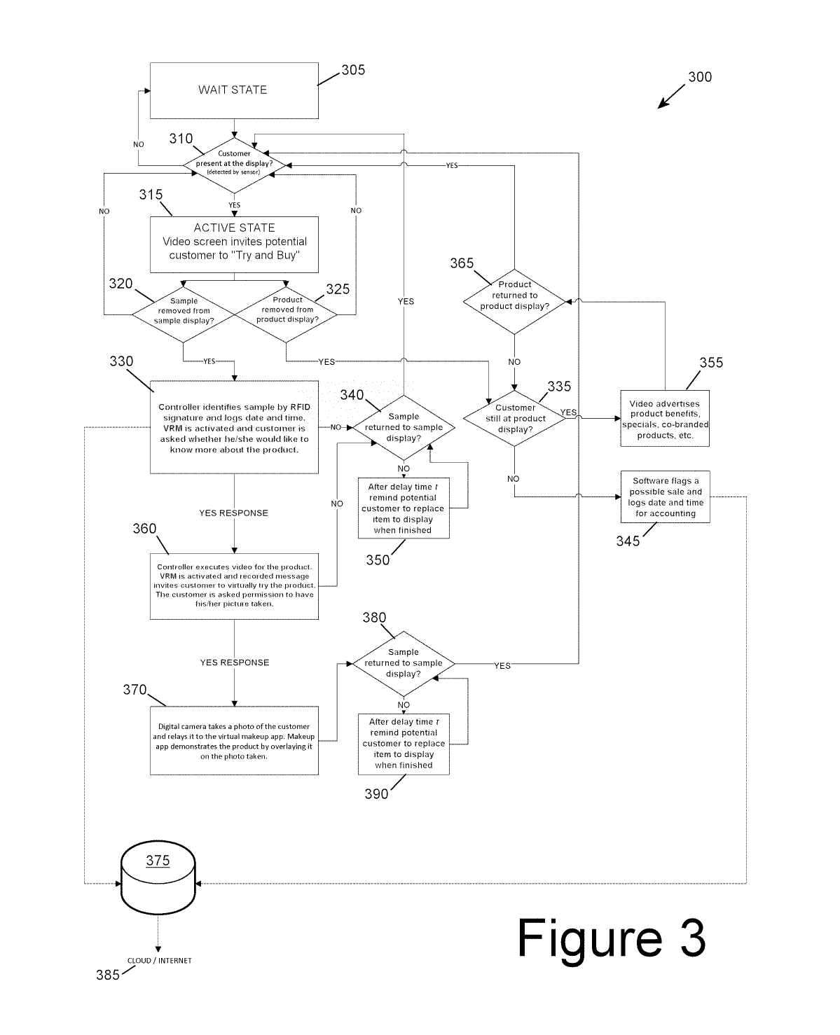

Integrating the RFID antenna array 130 with the display structure is one way to establish a generally homogenous RFID field 140 that would result in signal events occurring at about the same distance from the support structure. The distance, of course, may be preset by the designer by simply adjusting the strength of the energizing transmissions of the RFID reader 150. A cheaper way to buy an RFID reader right off the shelf and install it far enough away from the display structure that all or most of the items 120 are about the same distance from the RFID reader 150 along an axis of removal. For example, for the shelf-like display structure 170 shown in FIG. 2, a person lifting away an object would lift up and forward, towards herself, ergo we might want to place the RFID reader below and behind the surface of the display structure.

The signal event for the typical passive RFID tag is loss of signal, caused by the tag being brought too far away from the RFID reader 150. Because each tag returns a unique identifier when “observed” (i.e., the energizing signal broadcast by the reader that provides the energy needed for the tag to transmit) There are other ways of detecting the motion of passive tags that may be adapted to the disclosure. For example Jiang, Fishkin,, Roy, and Philipose disclose in their paper entitled “Unobtrusive Long-Range Detection of Passive RFID Tag Motion,” in IEE Transactions on Instrumentation and Measurement, Vol. 55, No. 1, February 2006, the disclosures of which are incorporated by reference herein in their entirety, disclose a method of detecting RFID tag distance by careful measurement of the time it takes the tag to respond to an observation. Other methods now being successfully investigated include designing small accelerometers inside the passive tags, such as is disclosed in Saxena and Voris, “Still and Silent: Motion Detection for Enhanced RFID Security and Privacy without Changing the Usage Model, Lecture Notes in Computer Science, Vol. 6370, 2010, pp 2-21, the disclosures of which are incorporated by reference herein in their entirety, and what is being referred to as Wireless Identification and Sensing Platform (WISP) a technology that used accelerometers in RFID tags passive or otherwise to track the position movement, and rotation of items, as described in Yeager and Smith, “WISP: A Passively Powered UHF RFID Tag with Sensing and Computation”, from Ahson and Ilyas, Editors, RFID Handbook: Applications, Technology, Security, and Privacy, CRC Press (2008), the disclosures of which are incorporated by reference herein in their entirety, and in U.S. Pat. Nos. 7,956,725 issued Jun. 7, 2011, and 7,336,184, issued Feb. 26, 2008, to Smith et al. the disclosures of which are incorporated by reference herein in their entirety.

Once an event occurs indicating an item 120 has been removed from the display structure 170, a controller 160 determines (or the RFID reader 150 makes this determination and informs the controller) what item (or items) have been removed and then accesses a multimedia store which will have audio, visual, or audiovisual information about the item 120 that has just been picked up. The controller then outputs the file information to an audio/visual I/O device (AVIO) 110.

Note how the disclosure can be used to “clinch” the sale of items for sale a in a retail establishment or at a convention, and the like, used for educational purposes to teach student details and specifications regarding various tools, parts, and so forth, or perhaps in a museum where, for example, the Geology section could have a number of minerals on display that the museum-goers could actually touch and handle.

Further, if anyone attempts to run off with any of the items, the controller 160 can be programmed to notify Security when an item is not returned to the display structure within a preset period of time and other RFID readers can make observation of the stolen item at the exits and adapted to the system.

Referring to FIG. 2, there is shown an embodiment of process steps 200 for operating the interactive item display system of the disclosure in the context of a retail establishment, as follows:
1. A customer picks up an item 120, a product or product sample for a closer look, causing an event (e.g., the ID tag No. for the product disappears from the list of observed ID tag nos.)
2. The RFID reader 150 detects the missing ID tag No.
3. The RFID reader 150 transmits the missing ID tag No. or (Nos.) to the controller 160.
4. The controller 160 locates to audio/visual file(s) for the missing ID tag No(s). and streams it(them) to the AVIO(s) 110.
5. The audio/visual file(s) appear(s) on the AVIO(s) 110.

Note how multiple videos can be made to appear either on multiple screens or by segmenting a single screen by software means. To do this simultaneously thought, one would generally desire the sound to play for only one of the presentations so as to prevent customer confusion. With multiple screens it may be desirable to play all silently after each playing a short sound bite announcing its presence, such announcements done in the order in which the items were picked up. Otherwise, the simplest solution is to only play one at a time, sequentially in the order the items were picked up, and possibly cancelling performance as necessary when an object is returned to the display structure prior to play.

### ISO Standards

Two RFID standards that will be found useful for use in the present disclosure are proximity and vicinity standards. Proximity standards would find use for small items and display structures where an event can is desired to be trigger by movement of an item any more than three (3) cm. This may be useful for chess pieces, small parts, and small fine jewelry.

Most retail items, such a perfume bottles, shoes, etc. may make use of the vicinity RFID standard of ISO/IEC 15693, which is disclosed in detail in the APPENDIX below. References are included at the end of the APPENDIX, the disclosures of which are incorporated therein in their entirety. An advantage of the vicinity RFID standard is flexibility—events can be set to trigger as far away from the reader as about 1.5 yards. The affords a wide range of display structure dimensions and item sizes.

Referring again to FIG. 4, there is shown a vicinity detector embodiment 400 of the structure of the disclosure in block diagram format. It can be seen that the controller 160 will generally comprise one or more I/O components that may be conceptually grouped together and classified as the I/O system, or simply “I/O 425 via which data is sent out and received through one or more data lines, D₀ through Dₙ. Also among those lines will often be an infrared detector port IR for the purposes of receiving remote control data. In some cases, the IR detector is onboard the controller 160 itself, other times on a separate board for flexibility of placement. This is convenient for our purposes because we may use the IR detector not for remote control purposes, but as a vicinity detector to determine if there is a human near the display system 100.

Referring to FIG. 5, there is shown a dual sample/product embodiment of the disclosure that comprises at least one sample display structure 170 and at least one product display 500. Here, the product display comprises a product display structure 510 in the form of shelving with products 120 for sale, not sampling, are available. In the embodiment shown, the product display structure 510 is close enough to the sample display structure as to be under the influence of the latter's RFID field such that an additional antenna is not required here.

Referring to FIG. 6, there is shown a flowchart 300 of the process of the controller 160 of the controller for a dual sample/product embodiment such as shown in FIG. 5. At node 103 the system is in a waiting state and the controller is broadcasting over the AVIO 110 and audio visual display designed to entice passerby to approach the display system 100, as it awaits a signal at node 310 that a customer or more has indeed approached. This signal would be from a proximity detector, such as a motion, infrared or other suitable detector.

Upon detection of a potential customer, control flows to node 315 where the system goes into an active state and switches to broadcasting A/V designed to entice the customer to sample and purchase the various goods. If a sample is removed from the sample display, control flows through 320 to node 330 where the controller ascertains what product has been taken and broadcasts the appropriate video. The date and time of the event is sent to a database 375, which may in turn relay the event externally 385. In this way statistics may be compiled.

Optionally, a voice recognition software module may be run by the controller to ask the customer if he/she would like to know more about the product. Alternatively, the controller can be programmed to go straight to node 360 and start espousing the virtues of the item 120 whether the customer wants to hear it or not.

At node 360, the controller might ask whether the customer would like to “virtually” try the product and, such as in the cases of cosmetics, tinted contact lenses, clothing items or the like, the controller will ask permission to image the customer.

If the customer agrees, control may then flow to node 370 wherein a virtual makeup module broadcasts a digitally created image of the customer with the makeup applied, or with the color contact lenses inserted, or wearing the clothing item. Data about his virtual try may also be sent to the database 375.

Notice at nodes 340, 350 and 380, 390, that the controller will occasionally inquire of a customer when an item has been picked up but not returned and the customer is still in proximity.

If a product, rather than a sample is removed from the product display 510, then control flows to node 335 via 325. The controller checks to make sure the customer is still around and, if not, control flows to node 345 where a possible sale (or theft) is flagged and logged for accounting (and security) and the system returns to the wait state at node 305.

If the customer is still at the display then control flows to node 355 where the controller outputs video designed to “close the sale. If unsuccessful, control flows back to 310 to wait to see if the customer picks up something else.

The foregoing disclosures relate to various embodiments of the disclosure and modifications may be made without departing from the spirit and scope of the invention as set forth in, and limited only by, the claims herein.

In the claims herein—unless explicitly indicated otherwise—the use of the word “or” is to be construed as the inclusive “or” in accordance with common usage in the engineering and computer arts.

What is claimed is:

1. An interactive item display system, comprising:
a display structure adapted to removably support at least one item, said item having at least one radio frequency identification (RFID) tag affixed thereto;
an RFID reader;
said RFID tag in a first identifying signal state detected by said RFID reader when the item is in a first configuration in removable support by said display structure;
said RFID tag in a second identifying signal state detected by said RFID reader when the item is in a second configuration unsupported by said display structure; and
an I/O device adapted to transmit information about said item upon detection of said second identifying signal state.
